(19) United States
(12) Patent Application Publication
(10) Pub. No.: US 2002/0061757 A1
(43) Pub. Date: May 23, 2002

(54) Variable mobile address lengths for efficient mobile paging and standby

(76) Inventor: Jason F. Hunzinger, Carlsbad, CA (US)

Correspondence Address: SCOTT C. HARRIS, Fish & Richardson P.C., Suite 500, 4350 La Jolla Village Drive, San Diego, CA, 92122, US

(21) Appl. No.: 09/989,801

(22) Filed: Nov. 19, 2001

Related U.S. Application Data
(60) Provisional application No. 60/252,997, filed on Nov. 22, 2000.

(51) Int. Cl. H04Q 7/20

(52) U.S. Cl. 455/458; 455/567

(57) ABSTRACT

In a wireless communication system, base stations transmit variable length portions of mobile addresses in paging messages (be it on forward common control channel, paging channel, or other channel that is monitored by mobiles in idle/standby). The variability in the address fields may consist of variable length and/or variable part (example: highest significant bits, lowest significant bits, etc). For efficiency, the portion of the address should be consecutive (for example, not some high order bits and some low order bits). The base station should select the length in a different manner than the portion.

### CROSS-REFERENCE TO RELATED APPLICATIONS

This application claims benefit of U.S. Provisional application No. 60/252,997, filed Nov. 22, 2000, the content of which is herein incorporated by reference in its entirety.

### TECHNICAL FIELD

This invention relates to wireless communication systems, and more particularly to transmitting variable length portions of mobile addresses in paging messages.

### BACKGROUND

The use of wireless communication systems is growing with users now numbering well into the millions. One of the most popular wireless communications systems is the cellular telephone, consisting of a mobile station (or handset) and a base station. Cellular telephones allow a user to talk over the telephone without having to remain in a fixed location. This allows users to, for example, move freely about the community while talking on the phone.

The wireless communication systems may communicate using the Code Division Multiple Access (CDMA) standard. CDMA is a communication standard permitting mobile users of wireless communication devices to exchange data over a telephone system wherein radio signals carry data to and from the wireless devices. A set of standards that define a version of CDMA that is particularly suitable for use with the invention include IS-95, IS-95A, and IS-95B, Mobile Station-Base Station Compatibility Standard for Dual-Mode Spread Spectrum Systems; TIA/EIA/IS-2000-2, Physical Layer Standard for cdma2000 Spread Spectrum Systems; and TIA/EIA/IS-2000-5 Upper Layer (Layer 3) Signaling Standard for cdma2000 Spread Spectrum Systems, all of which are herein incorporated by reference in their entirety.

Each mobile station in a CDMA network has a unique address to communicate with the base station. Typically, the base station transmits the entire address of the mobile station over a channel such as the paging channel. However, transmission of the entire address consumes a large potion of the network resources. What is desired is the ability to address the mobile station using less network resources.

### SUMMARY

The present invention comprises base stations transmitting variable length portions of mobile addresses in paging messages (be it on forward common control channel, paging channel, or other channel that is monitored by mobiles in idle/standby). The variability in the address fields may consist of variable length and/or variable part (example: highest significant bits, lowest significant bits, etc). For efficiency, the portion of the address should be consecutive (for example, not some high order bits and some low order bits). The base station should select the length in a different manner than the portion.

### DESCRIPTION OF DRAWINGS

These and other features and advantages of the invention will become more apparent upon reading the following detailed description and upon reference to the accompanying drawings.

FIG. 1 illustrates the components of an exemplary wireless communication system used by one embodiment of the present invention.

FIG. 2 is a block diagram showing features of a mobile station according to one embodiment of the invention.

FIG. 3 illustrates a process for transmitting variable length portions of a mobile address according to one embodiment of the invention.

### DETAILED DESCRIPTION

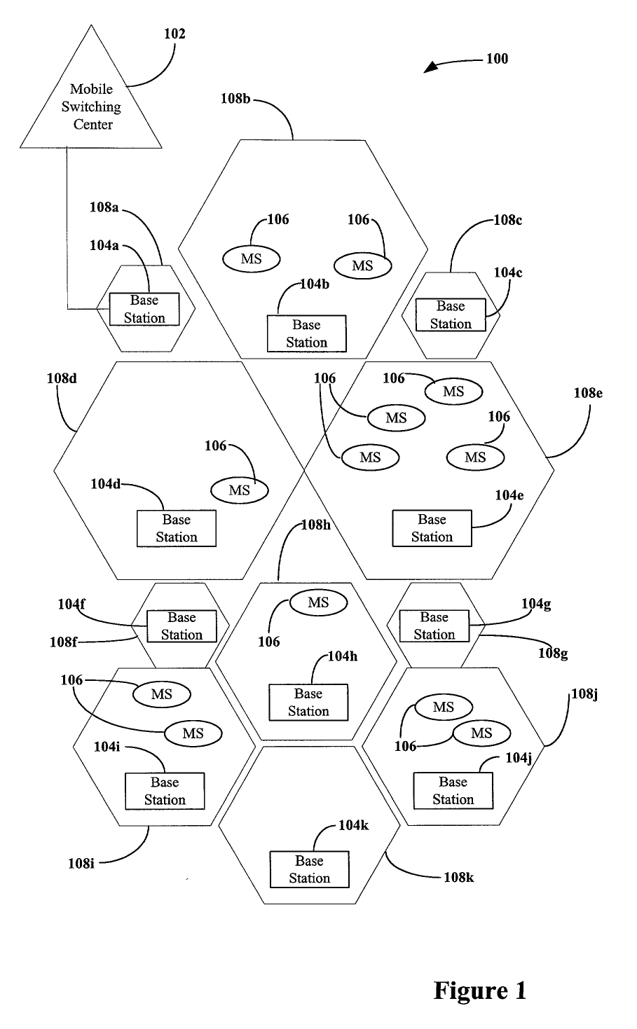

FIG. 1 illustrates components of an exemplary wireless communication system 100. A mobile switching center 102 communicates with base stations 104a-104k (only one connection shown). The base stations 104a-104k (generally 104) broadcasts data to and receives data from mobile stations 106 within cells 108a-108k (generally 108). The cell 108, corresponding to a geographic region, is served by a base station. Practically, said geographic regions often overlap to a limited extent.

A mobile station 106 is capable of receiving data from and transmitting data to a base station 104. In one embodiment, the mobile station 106 receives and transmits data according to the CDMA standards. Under the CDMA standards, additional cells 108a, 108c, 108d, and 108e adjacent to the cell 108b permit mobile stations 106 to cross cell boundaries without interrupting communications. This is so because base stations 104a, 104c, 104d, and 104e in adjacent cells assume the task of transmitting and receiving data for the mobile stations 106. The mobile switching center 102 coordinates all communication to and from mobile stations 106 in a multi-cell region. Thus, the mobile switching center 102 may communicate with many base stations 104.

Mobile stations 106 may move about freely within the cell 108 while communicating either voice or data. Mobile stations 106 not in active communication with other telephone system users may, nevertheless, scan base station 104 transmissions in the cell 108 to detect any telephone calls or paging messages directed to the mobile station 106.

One example of such a mobile station 106 is a cellular telephone used by a pedestrian who, expecting a telephone call, powers on the cellular telephone while walking in the cell 108. The cellular telephone scans certain frequencies (frequencies known to be used by CDMA) to synchronize communication with the base station 104. The cellular telephone then registers with the mobile switching center 102 to make itself known as an active user within the CDMA network.

At times it is desirable for a different base station 104 to communicate with the mobile station 106. This may be due to the original base station 104 losing signal strength, the mobile station 106 traveling out of range of the original base station 104, or other factors. When the mobile station 106 changes base stations 104, it is referred to as a handoff. Currently, one technique for determining if a handoff is to occur is to monitor the energy level of a pilot signal from a base station. If the energy level of the pilot signal falls below a predetermined threshold for a specific period of time, the mobile station 106 initiates a handoff.

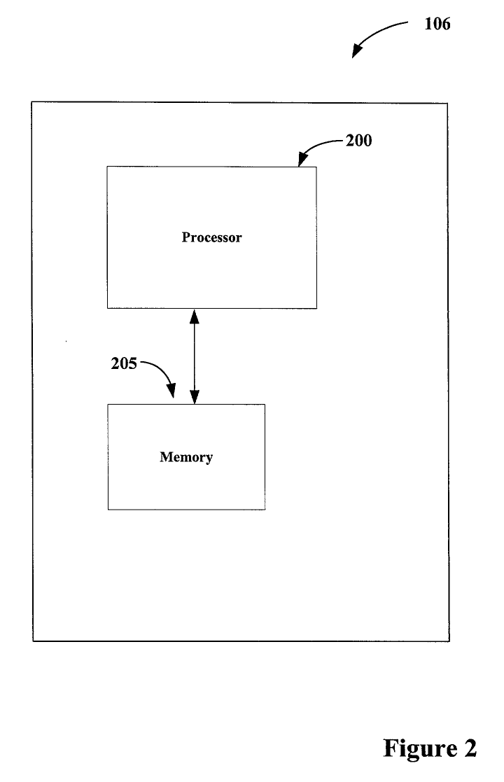

FIG. 2 shows a block diagram of the mobile station 106, including a processor 200 and memory 205. The processor 200 may be driven by a program stored in the memory 205. A portion of memory 210 may be used to store search parameters.

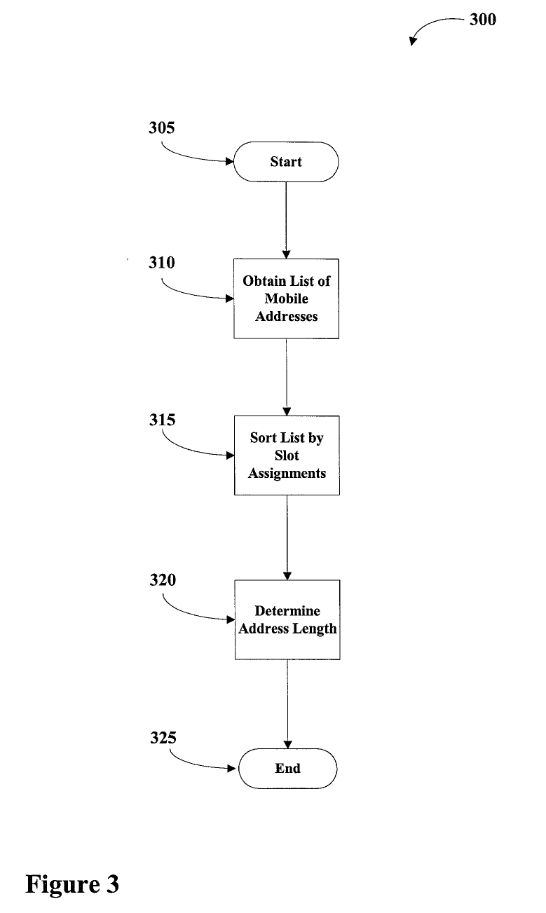

FIG. 3 illustrates a process 300 for transmitting variable length portions of a mobile address according to one embodiment of the invention. The process begins in a START block 305. Proceeding to block 310, the base station 104 acquires a list of addresses of all the mobile stations 106 currently in communication with the base station 104. The base station 104 typically transmits the address of a mobile station 106 over a paging message (such as over a common control channel, a paging channel, or any other channel the mobile station 106 is monitoring). When the mobile station 106 receives its designated address, the mobile station 106 remains awake and continues to monitor the channel for further information (such as an incoming call). If the base station 104 is communicating with 15 different mobile stations 106, then the base station 104 should have a list of 15 unique addresses.

Proceeding to block 315, the base station 104 may organize the address list based on slot assignment. As is well known, mobile stations 106 may be assigned to monitor a specific slot to look for its address. The total number of mobile stations 106 communicating with the base station 104 may be spread over the multiple slots, so that only a few mobile stations 106 are monitoring each slot. The base station 104 may then sort the addresses of each mobile station 106 by the slot assignments. Although each address of the mobile stations 106 are unique, taking a partial address for each mobile station 106 may result in duplication. For example, if the address is a 16 bit field, taking a 6 bit partial address (say bits 4-9) may result in the same partial address for two different mobile stations 106. However, if these mobile stations 106 are monitoring different slots, there would be no conflict. Thus, the base station 104 may sort the list by slot assignment to further reduce the size of the necessary partial address length.

Proceeding to block 320, the base station 104 determines a partial address length of each slot location. The length should be determined so that the partial addresses for the all the pages for the mobile stations 106 that will be monitoring a specific slot is minimized. In cdmaOne and cdma2000, it is preferable to maintain the total length of the partial addresses (including associated header and wrapping information such as number of page addresses), to the frame length or less. The reason is that one frame is a single unit for the CDMA de-interleaver to deal with. For efficiency, the portion of the address should be consecutive (for example, not some high order bits and some low order bits).

The portion of each address to transmit/broadcast on the forward common channel, can be the same or different for each partial address. To simplify calculations, the infrastructure may choose to use the same portion for all of the partial addresses in a slot. To increase efficiency, the infrastructure may choose to use different portions but there will be increased overhead to transmit details on the portions to the mobile which will affect the length selection. Whichever method is used, the infrastructure shall select the portion according to the probabilities of mobiles miss-detecting the partial address as their own and staying awake. The infrastructure knows which mobile stations 106 have registered and the characteristics of individual addresses and their types (IMSI, TMSI, etc), and may therefore calculate the probabilities. The infrastructure should minimize the overall number of mobile stations 106 that will remain awake to continue to monitor the channel.

A number of embodiments of the invention have been described. Nevertheless, it will be understood that various modifications may be made without departing from the spirit and scope of the invention. Accordingly, other embodiments are within the scope of the following claims.

What is claimed is:

1. A method of addressing mobile stations in a wireless communication system comprising:
obtaining a list of mobile addresses; and
determining a partial address length and portion to communicate with each mobile station.

2. The method of claim 1, further comprising sorting the list of mobile addresses by slot location so that each mobile station a slot has a unique partial address.

3. The method of claim 2, further comprising selecting different partial address lengths for different slots.

4. The method of claim 1, further comprising selecting a consecutive portion of the address as the partial address.

5. The method of claim 1, further comprising setting the partial address length to a frame length or less.

6. The method of claim 1, further comprising selecting a partial address length to minimize the bits transmitted by the wireless communication system.

7. The method of claim 6, further comprising addressing the mobile stations using addresses of the partial address length.

8. A wireless communication system comprising:
a plurality of mobile stations, wherein each mobile station has a unique address;
a base station which communicates with the plurality of mobile stations, the base station comparing the addresses of each mobile station to determine a partial address length at which each mobile station may be uniquely identified.

9. The wireless communication system of claim 8, wherein each of the mobile stations monitors a specific slot for its address.

10. The wireless communication system of claim 9, wherein the base station determines a partial address length at which each mobile station with a specific slot may be uniquely identified.

11. The wireless communication system of claim 10, wherein the partial address length may vary between slots.

12. The wireless communication system of claim 8, wherein the partial address is selected from consecutive bits of the unique address.

13. The wireless communication system of claim 8, wherein the partial address length is a frame length or less.

14. A method of varying the address length in a wireless communication system comprising:
selecting a partial address length which results in each terminal of the wireless communication system obtaining a unique partial address.

15. The method of claim 14, further comprising dividing the addresses into groups based on the monitored slot, wherein each address in a group is unique.

16. The method of claim 15, further comprising permitting different address lengths in each group.

17. The method of claim 14, further comprising using consecutive bits of a terminal address to create the unique partial address.
